(19) United States
(12) Patent Application Publication
(10) Pub. No.: US 2001/0032117 A1
(43) Pub. Date: Oct. 18, 2001

(54) Continuous and updatable revenue sharing process for lists

(76) Inventor: Robert E. Persky, Rhinebeck, NY (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/824,834

(22) Filed: Apr. 3, 2001

Related U.S. Application Data
(60) Provisional application No. 60/195,531, filed on Apr. 7, 2000.

(51) Int. Cl. G06F 17/60

(52) U.S. Cl. 705/10

(57) ABSTRACT

Revenues generated from the rental, sale and exchange of lists compiled by “list owners” and used by “list users” are periodically shared with “listed individuals” who provided personal data that appears on the lists. The portions of revenue credited to each of the listed individuals are determined based upon whether a list including the listed individual generated revenue, the quality of data provided (e.g., periodically updated information) and the quantity of data provided (e.g., percentage of questions answered in a questionnaire).

### CROSS-REFERENCE TO RELATED APPLICATIONS

This application claims the benefit of U.S. Provisional Application No. 60/195,531 filed Apr. 7, 2000, entitled “BUSINESS METHOD FOR COMPILING MAILING LISTS AND E-MAIL LISTS, ENHANCING THEIR DATA AND MAINTAINING THEIR ACCURACY.”

### BACKGROUND OF THE INVENTION

The list rental business (whether snail-mail or e-mail), as presently structured, involves the payment to a list owner of a rental fee for a one-time use or, in some instances, multiple uses. In some instances, a list manager or broker (other than the list owner) is interposed between the list owner and the list renter. Those individuals, businesses and institutions included on the list are referred to as names or listed individuals.

Mail list rental fees generally range from $45 per thousand names to $200 per thousand names. The more specific the list, the higher the fee. The lowest category is a list compiled from available public information. For example, most business specific lists are compiled from the yellow pages. A trade association list which contains the names of top management and job titles, rents for more that a compiled list for the same industry. Controlled circulation lists of industry publications are another source for industry lists since they often list job titles.

Consumer response lists rent for higher fees, since the names have demonstrated that they will respond to a direct mail or e-mail offer, e.g., magazine subscription, consumer goods or service. Specific consumer segmented lists rent at premiums from the lowest fees, e.g. senior citizens who use anti-acids, own second homes, have arthritis or other ailments. The specific segments are obtained from direct response, questionnaires offering discount coupons for responding, and questionnaires included with warranty and guarantee forms.

In each instance, there is a cost in compiling and maintaining the list such that the list rental fee is not all profit. Maintenance is particularly difficult because the listed individuals move, marry, divorce, die, and change interests. Moreover, zip codes change and, in electronic lists, listed individuals change their internet providers (and thus their e-mail address) and/or their screen names. Business names change because of mergers, acquisitions, discontinuance of business, changes in personnel and/or job titles.

In summary, the maintenance of a list involves:

(1) Correcting addresses resulting from moving, such as zip code changes and street name changes.

(2) In the case of electronic lists, changes in e-mail providers, user IDs and e-mail addresses.

(3) Changing names due to marriages, divorces, deaths, and misspellings in transcription.

(4) Augmenting data on the lists relating to age, education, income, interests, recreational preferences, food preferences, home ownership or rental, marital status, and employment.

Maintenance and adding data valuable to the list user poses a major expense to the list owner and/or those who purchase, rent or exchange lists. In addition to being expensive, it involves a never-ending continuous cycle and thus no list of any size is ever completely up-to-date.

Historically, the revenue obtained by the owners of compiled and/or response lists is retained by the list owners or shared with list managers and/or brokers. None of the revenue is shared with the listed individuals whose names and personal information appear on the lists, although some compilers of e-mail lists offer “one-time” incentives for listed individuals who provide personal information (but not continuous revenue sharing). Other list services, such as “ListPower™,” an EzerNet™ company, share revenue between the list service and the list owners. What is needed is a way to provide listed individuals with a long term incentive to provide and update list information.

### SUMMARY OF THE INVENTION

The present invention provides monetary incentives to individuals whose personal information appears on a list (e.g., mailing list, e-mail list), such that the individuals provide information deemed to be useful to a potential user of the list, and update such-information on a periodic basis.

At present, many large employers discard, at the mail room level, all non-first-class mail not addressed by name to their employees. The present invention will encourage listed individuals to supply their job titles and employer addresses so as to permit a larger percentage of business-to-business communications to reach the correct individual.

The present invention will motivate listed individuals to voluntarily provide and frequently update their own names, addresses and data. The present invention will also substantially overcome the concern about privacy of data since all of the data being provided will be provided voluntarily with full knowledge that it will be shared and that the sharing will result in an economic benefit to the individual.

The present invention involves continuous sharing revenue from the rental, sale, or exchange of mailing lists, e-mail lists, and other electronically compiled lists (collectively “lists”) with the listed individuals who agree: (i) to be included on the lists, (ii) to provide data about themselves which permits targeted messages, and (iii) to periodically update their addresses and other data.

To encourage listed individuals to provide the detailed data which makes a list more valuable, the percentage of participation in rentals will be increased from a fixed minimum percentage to a fixed maximum, depending on the percentage of the questionnaire completed.

Continuous participation of the listed individuals in maintaining their own data will be encouraged by varying the percentage of revenue sharing, e.g., increasing up to a specified maximum for periodic updating and decreasing for failure to update.

A computer-implemented method of sharing revenue with listed individuals in accordance with the present invention is now described. The listed individuals provide personal data to a list owner and agree to allow the list owner to make the personal data accessible to a list user. The listed individuals communicate with the list owner via an electronic communication medium.

In a preferred embodiment of the present invention, a listed individual is electronically solicited to agree to a predetermined set of conditions regarding the provision and handling of personal data related to the listed individual. For example, this may occur when the listed individual logs onto the Internet and visits a list owner's website, or a list broker's website running on behalf of a list owner. If the listed individual wishes to participate, the list owner's website electronically receives an indication that the listed individual agrees to the predetermined set of conditions. The listed individual is then electronically solicited for personal data. The list owner's website electronically receives and stores personal data related to the listed individual. From that point on, the website determines, on a periodic basis, whether revenue was received in exchange for providing the list user with access to a list including the personal data of the listed individual. If it is determined that revenue was received, the website determines a portion of the revenue to be credited to the listed individual.

When the listed individual is initially solicited to agree to the predetermined set of conditions, the listed individual may be presented with an offer to credit to the listed individual a portion of future revenue to be received from the sale, rental or exchange of one or more lists that include the listed individual's personal data to a list user.

The personal data may include answers to questions presented in a questionnaire. The portion of revenue to be credited to the listed individual may be based on the percentage of the questions in the questionnaire that were answered by the listed individual. A fixed minimum and a fixed maximum percentage of the revenue to be credited may be set. The portion of the revenue to be credited may then be determined based on the percentage of questions answered, the fixed minimum percentage and the fixed maximum percentage.

The listed individual may be electronically requested to update the personal data related to the listed individual (e.g., such as by e-mail). The list owner may then electronically receive and store updated personal data associated with the listed individual. The listed individual's responsiveness to the periodic requests to update personal data related to the listed individual may be evaluated. The portion of the revenue to be credited to the listed individual may then be determined based on the evaluation of the listed individual's responsiveness. A fixed minimum and a fixed maximum percentage of the revenue to be credited may be set. The portion of the revenue to be credited may then be determined based on the evaluation of the listed individual's responsiveness, the fixed minimum percentage and the fixed maximum percentage.

The predetermined set of conditions may include:

(1) The listed individual agreeing to provide personal data related to the listed individual that will be included on a list that is to be included in a future transaction that generates revenue.

(2) The listed individual agreeing to update the personal data on a periodic basis.

(3) The listed individual agreeing to be subject to targeted messages based on the personal data.

Personal data may include at least one of the listed individual's name, telephone number, home address, e-mail address, employer name, employer address, job title, age, income, education, interests, recreational preferences, food preferences, home ownership or rental status, medical ailments, medication intake and marital status.

In a second embodiment of the present invention, a listed individual is electronically solicited for personal data. For example, this may occur when the listed individual logs onto the Internet and visits a list owner's website, or a list broker's website running on behalf of a list owner. The list owner's website electronically receives and stores personal data related to the listed individual. The listed individual is then electronically requested, on a periodic basis, to update the personal data related to the listed individual (e.g., such as by e-mail). The portion of the revenue to be credited to the listed individual is determined based on whether or not revenue was received in exchange for providing the list user with access to a list including the listed individual's personal data, and an evaluation of the responsiveness of the listed individual to the periodic requests to update personal data associated with the listed individual.

The listed individual may be electronically solicited to agree to a predetermined set of conditions regarding the provision and handling of personal data related to the listed individual. The list owner may then electronically receive an indication that the listed individual agrees to the predetermined set of conditions.

In a third embodiment of the present invention, a listed individual is electronically solicited for personal data related to the listed individual, wherein the personal data includes answers to questions presented in a questionnaire. For example, this may occur when the listed individual logs onto the Internet and visits a list owner's website, or a list broker's website running on behalf of a list owner. The list owner's website electronically receives and stores personal data related to the listed individual. On a periodic basis, the portion of the revenue to be credited to the listed individual is then determined based on whether or not revenue was received in exchange for providing the list user with access to a list including the personal data of the listed individual, and the percentage of the questions in the questionnaire that were answered by the listed individual. Additional questionnaires may be presented to the listed individual from time-to-time, as determined by the list owner and/or list user.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 shows a block diagram of an electronic list owner interface in accordance with the present invention;

FIG. 2 shows a flow diagram in accordance with a preferred embodiment of the present invention;

FIG. 3 shows a flow diagram in accordance with a second embodiment of the present invention; and

FIG. 4 shows a flow diagram in accordance with a third embodiment of the present invention.

### DETAILED DESCRIPTION OF THE INVENTION

Certain terminology is used herein for convenience only and is not to be taken as a limitation on the present invention. A “list” is a collection of personal data associated with one or more individuals. A list may be a mailing list, an e-mail list, or any other electronically compiled lists. A “list owner” is a person, business or other entity that compiles a list for future distribution to one or more “list users.” A “list user” (e.g., list renter, list customer) is a person, business or other entity that uses the list. A list owner may employ one or more list brokers/agents/managers who merely serve as a representative for the list owner. The list user may either purchase the list, rent the list, or exchange another list for the list. A “listed individual” (e.g., name) is a person, business or other entity that grants the list owner permission to use information about the listed individual on the list.

The most economic method of commencing list compilation involves the use of a website which is essentially a relational database. The website enables a listed individual to commence entering information, create a unique name code, and log off at any point and return at a later date to complete or change information. It is contemplated that commercially available databases will be used, thus requiring little customization.

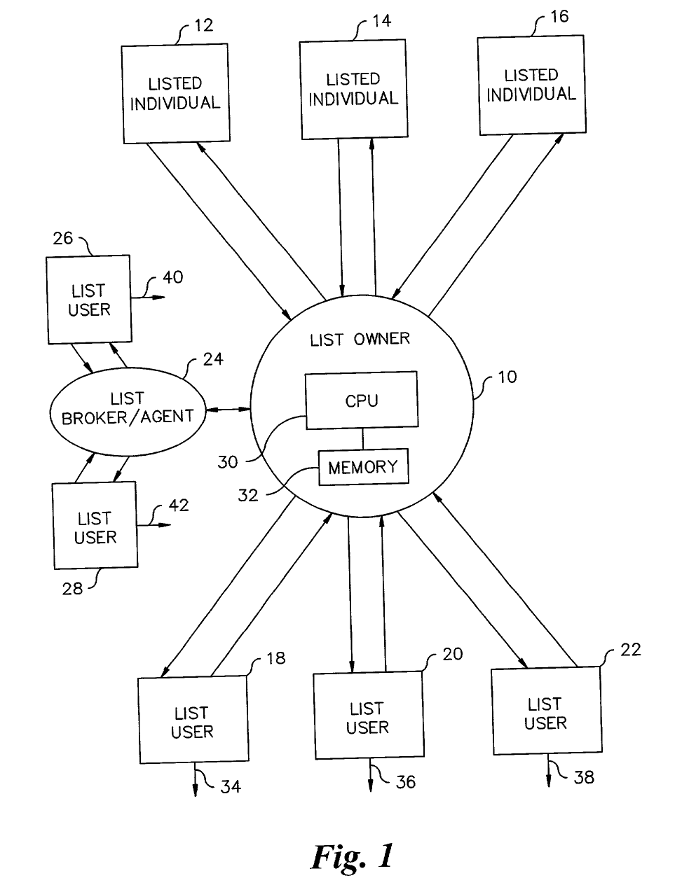

FIG. 1 shows a list owner website 10 in accordance with the present invention. List owner website 10 communicates with listed individuals 12, 14, 16, and with list users 18, 20 and 22 via an electronic communication medium, such as the Internet. List owner website 10 also communicates with one or more list brokers/agents 24 which serve as an intermediary between additional list users 26, 28 and the list owner website 10. List owner website 10 includes a computer processing unit (CPU) 30 and a database (memory 32).

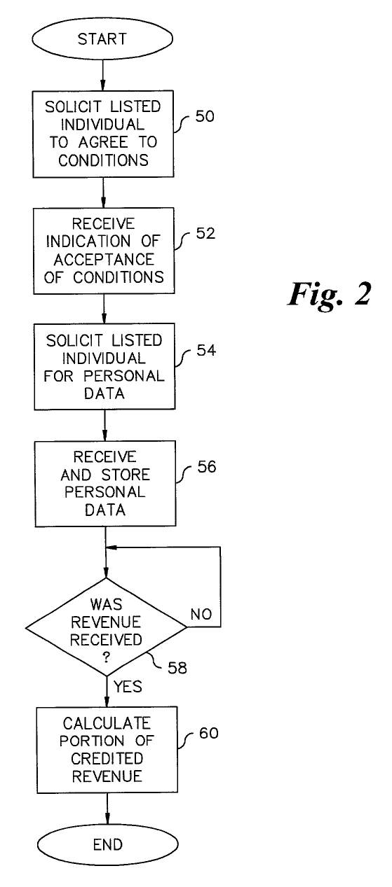

FIG. 2 shows a flow chart for a computer-implemented method of sharing revenue with listed individuals 12, 14, 16 in accordance with the preferred embodiment of the present invention. In block 50, listed individuals 12, 14, 16 log onto the Internet and, upon visiting list owner website 10 for the first time, are electronically solicited by list owner website 10 to agree to a predetermined set of conditions regarding the provision and handling of personal data related to the respective listed individuals 12, 14 and 16. In block 52, the list owner's website 10 electronically receives an indication that the listed individuals 12, 14, 16 agree to the predetermined set of conditions. In block 54, listed individuals 12, 14, 16 are then electronically solicited for personal data. In block 56, the list owner's website 10 electronically receives and stores in memory 32, personal data related to the listed individuals 12, 14 and 16. From that point on, as shown in block 58, the list owner's website 10 determines, on a periodic basis, whether revenue was received in exchange for providing the list user with access to a list including the personal data of the listed individual. In block 60, if it is determined that revenue was received, the list owner's website 10 determines a portion of the revenue to be credited to the listed individuals 12, 14 and 16.

When the listed individuals 12, 14, 16 are initially solicited to agree to the predetermined set of conditions, each listed individual is presented with an offer to credit to the listed individuals a portion of future revenue to be received from the sale, rental or exchange of one or more lists that include the respective listed individual's personal data to a list user. Electronic solicitations may be presented by displaying text, outputting audible messages using voice synthesis, or other known means of communicating.

The personal data may include answers to questions presented in a questionnaire. The portion of revenue to be credited to the listed individual may be based on the percentage of the questions in the questionnaire that were answered by the listed individual. A fixed minimum and a fixed maximum percentage of the revenue to be credited may be set. The portion of the revenue to be credited may then be determined based on the percentage of questions answered, the fixed minimum percentage and the fixed maximum percentage.

Each listed individual 12, 14, 16 may be electronically requested to update the personal data related to the respective listed individual (e.g., such as by e-mail). The list owner website 10 may then electronically receive and store updated personal data associated with the listed individual. The listed individual's responsiveness to the periodic requests to update personal data related to the listed individual may be evaluated. The portion of the revenue to be credited to the listed individual may then be determined based on the evaluation of the listed individual's responsiveness. A fixed minimum and a fixed maximum percentage of the revenue to be credited may be set. The portion of the revenue to be credited may then be determined based on the evaluation of the listed individual's responsiveness, the fixed minimum percentage and the fixed maximum percentage.

The predetermined set of conditions may include:

(1) The listed individual agreeing to provide personal data related to the listed individual that will be included on a list that is to be included in a future transaction that generates revenue.

(2) The listed individual agreeing to update the personal data on a periodic basis.

(3) The listed individual agreeing to be subject to targeted messages based on the personal data. Such target messages are outputted from list users 18, 20, 22, 26, 28 via outputs 34, 36, 38, 40 and 42.

Personal data may include at least one of the listed individual's name, telephone number, home address, e-mail address, employer name, employer address, job title, age, income, education, interests, recreational preferences, food preferences, home ownership or rental status, medical ailments, medication intake and marital status.

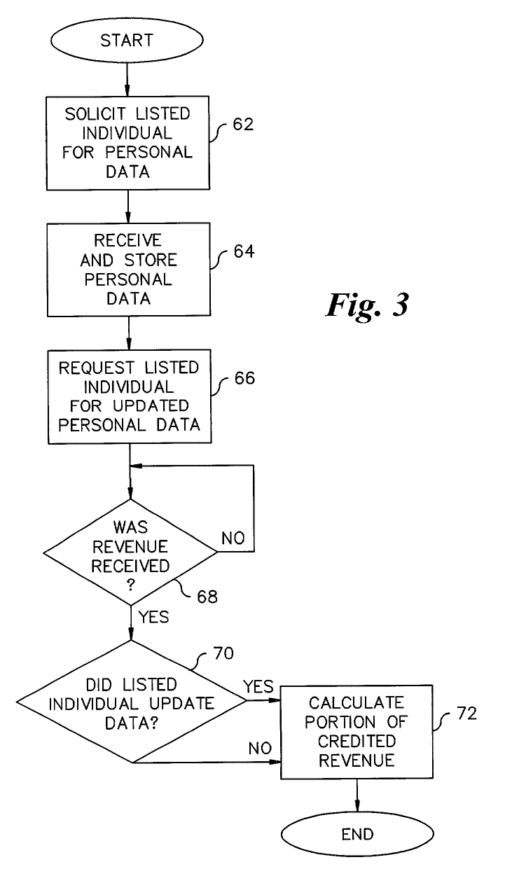

FIG. 3 shows a flow chart for a computer-implemented method of sharing revenue with listed individuals 12, 14, 16 in accordance with a second embodiment of the present invention. In block 62, a listed individual is electronically solicited for personal data. In block 64, the list owner's website 10 electronically receives and stores in memory 32, personal data related to the listed individual. In block 66, the listed individual is then electronically requested, on a periodic basis, to update the personal data related to the listed individual (e.g., such as by e-mail). In decision block 68, the list owner's website 10 determines, on a periodic basis, whether or not revenue was received in exchange for providing the list user with access to a list including the listed individual's personal data. If it is determined in decision block 68 that revenue was received, an evaluation of the responsiveness of the listed individual to the periodic requests to update personal data associated with the listed individual is determined in decision block 70. In block 72, the list owner's website 10 determines a portion of the revenue to be credited to the listed individual. Each of listed individuals 12, 14, 16 may receive different portions of the revenue, depending upon the results of the evaluation.

The listed individual may be electronically solicited to agree to a predetermined set of conditions regarding the provision and handling of personal data related to the listed individual. The list owner may then electronically receive an indication that the listed individual agrees to the predetermined set of conditions.

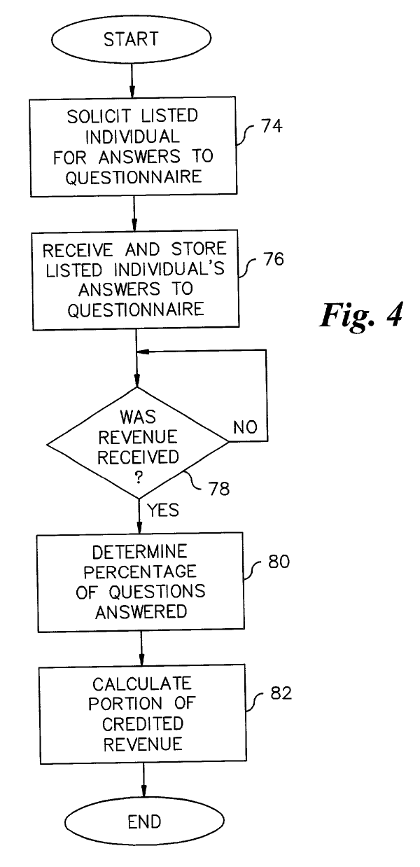

FIG. 4 shows a flow chart for a computer-implemented method of sharing revenue with listed individuals 12, 14, 16 in accordance with a third embodiment of the present invention. In block 74, a listed individual is electronically solicited for personal data related to the listed individual, wherein the personal data includes answers to questions presented in a questionnaire. For example, this may occur when the listed individual logs on to the Internet and visits the list owner's website 10 for a first or subsequent time. In block 76, the list owner's website 10 electronically receives and stores in memory 32, the listed individual's answers to some or all of the questions presented in the questionnaire. In decision block 78, the list owner's website 10 determines, on a periodic basis, whether or not revenue was received in exchange for providing the list user with access to a list including the listed individual's personal data. If it is determined in decision block 78 that revenue was received, the percentage of questions in the questionnaire answered by the listed individual is determined in block 80. In block 82, the list owner's website 10 determines a portion of the revenue to be credited to the listed individual. Each of listed individuals 12, 14, 16 may receive different portions of the revenue, depending upon the percentage of questions answered by the respective listed individuals 12, 14 and 16.

On a periodic basis, the portion of the revenue to be credited to the listed individual is then determined based on whether or not revenue was received in exchange for providing the list user with access to a list including the personal data of the listed individual, and the percentage of the questions in the questionnaire that were answered by the listed individual. Additional questionnaires may be periodically presented to the listed individual, as determined by the list owner and/or list user.

Pop-up display windows (e.g., instant messaging) may be used to keep the data entry screens from appearing too intimidating. For example, if a listed individual indicated that they owned an automobile, only then would a pop-up window emerge with a list of brands and model types. If a listed individual indicated that he or she had arthritis, only then would a pop-up window emerge with a list of pharmaceuticals. Interest of the listed individuals is maintained by augmenting the increased revenue sharing percentage with the concurrent offering of coupons for free and/or discounted goods and services.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A computer-implemented method of sharing revenue with listed individuals, wherein the listed individuals provide personal data to a list owner and agree to allow the list owner to make the personal data accessible to a list user, the listed individuals communicating with the list owner via an electronic communication medium, the method comprising:
(a) electronically soliciting a listed individual to agree to a predetermined set of conditions regarding the provision and handling of personal data related to the listed individual;
(b) electronically receiving an indication that the listed individual agrees to the predetermined set of conditions;
(c) electronically soliciting the listed individual for personal data;
(d) electronically receiving and storing personal data related to the listed individual;
(e) determining, on a periodic basis, whether revenue was received in exchange for providing the list user with access to a list including the personal data of the listed individual, and, if so, determining a portion of the revenue to be credited to the listed individual.

2. The method of claim 1, wherein the solicitation in step (a) includes an offer to credit to the listed individual a portion of future revenue to be received from the sale, rental or exchange of one or more lists that include the listed individual's personal data to a list user.

3. The method of claim 1, wherein the personal data includes answers to questions presented in a questionnaire.

4. The method of claim 3, wherein step (e) further comprises:
(i) determining the percentage of the questions in the questionnaire that were answered by the listed individual; and
(ii) determining the portion of the revenue to be credited to the listed individual based on the percentage of questions answered.

5. The method of claim 4, wherein step (e)(ii) further comprises:
(a) setting a fixed minimum percentage of the revenue to be credited;
(b) setting a fixed maximum percentage of the revenue to be credited; and
(c) determining the portion of the revenue to be credited, based on the percentage of questions answered, the fixed minimum percentage and the fixed maximum percentage.

6. The method of claim 1, further comprising:
(f) electronically requesting, on a periodic basis, the listed individual to update the personal data related to the listed individual; and
(g) the list owner electronically receiving and storing updated personal data associated with the listed individual.

7. The method of claim 6, wherein step (e) further comprises:
(i) evaluating the listed individual's responsiveness to the periodic requests to update personal data related to the listed individual; and
(ii) determining the portion of the revenue to be credited to the listed individual based on the evaluation of the listed individual's responsiveness.

8. The method of claim 7, wherein step (e)(ii) further comprises:
(a) setting a fixed minimum percentage of the revenue to be credited;
(b) setting a fixed maximum percentage of the revenue to be credited; and
(c) determining the portion of the revenue to be credited, based on the evaluation of the listed individual's responsiveness, the fixed minimum percentage and the fixed maximum percentage.

9. The method of claim 1, wherein the predetermined set of conditions include the listed individual agreeing to provide personal data related to the listed individual that will be included on a list that is to be included in a future transaction that generates revenue, update the personal data on a periodic basis, and be subject to targeted messages based on the personal data.

10. The method of claim 1, wherein the personal data includes at least one of the listed individual's name, telephone number, home address, e-mail address, employer name, employer address, job title, age, income, education, interests, recreational preferences, food preferences, home ownership or rental status, medical ailments, medication intake and marital status.

11. A computer-implemented method of sharing revenue with listed individuals, wherein the listed individuals provide personal data to a list owner and agree to allow the list owner to make the personal data accessible to a list user, the listed individuals communicating with the list owner via an electronic communication medium, the method comprising:
(a) electronically soliciting a listed individual for personal data;
(b) electronically receiving and storing personal data related to the listed individual;
(c) electronically requesting, on a periodic basis, the listed individual to update the personal data related to the listed individual; and
(d) determining, on a periodic basis, the portion of the revenue to be credited to the listed individual based on whether or not revenue was received in exchange for providing the list user with access to a list including the listed individual's personal data, and an evaluation of the responsiveness of the listed individual to the periodic requests to update personal data associated with the listed individual.

12. The method of claim 11, wherein the solicitation in step (a) includes an offer to credit to the listed individual a portion of future revenue to be received from the sale, rental or exchange of one or more lists that include the listed individual's personal data to a list user.

13. The method of claim 11, wherein if revenue was received, step (d) further comprises:
(i) setting a fixed minimum percentage of the revenue to be credited;
(ii) setting a fixed maximum percentage of the revenue to be credited; and
(iii) determining the portion of the revenue to be credited, based on the evaluation of the listed individual's responsiveness, the fixed minimum percentage and the fixed maximum percentage.

14. The method of claim 11, further comprising:
(e) electronically soliciting the listed individual to agree to a predetermined set of conditions regarding the provision and handling of personal data related to the listed individual; and
(f) the list owner electronically receiving an indication that the listed individual agrees to the predetermined set of conditions.

15. The method of claim 14, wherein the predetermined set of conditions include the listed individual agreeing to provide personal data related to the listed individual that will be included on a list that is to be included in a future transaction that generates revenue, update the personal data on a periodic basis, and be subject to targeted messages based on the personal data.

16. The method of claim 11, wherein the personal data includes at least one of the listed individual's name, telephone number, home address, e-mail address, employer name, employer address, job title, age, income, education, interests, recreational preferences, food preferences, home ownership or rental status, medical ailments, medication intake and marital status.

17. A computer-implemented method of sharing revenue with listed individuals, wherein the listed individuals provide personal data to a list owner and agree to allow the list owner to make the personal data accessible to a list user, the listed individuals communicating with the list owner via an electronic communication medium, the method comprising:
(a) electronically soliciting a listed individual for personal data related to the listed individual, wherein the personal data includes answers to questions presented in a questionnaire;
(b) electronically receiving and storing personal data related to the listed individual; and
(c) determining, on a periodic basis, the portion of the revenue to be credited to the listed individual based on whether or not revenue was received in exchange for providing the list user with access to a list including the personal data of the listed individual, and the percentage of the questions in the questionnaire that were answered by the listed individual.

18. The method of claim 17, wherein the solicitation in step (a) includes an offer to credit to the listed individual a portion of future revenue to be received from the sale, rental or exchange of one or more lists that include the listed individual's personal data.

19. The method of claim 17, wherein if revenue was received, step (c) further comprises:
(i) setting a fixed minimum percentage of the revenue to be credited;
(ii) setting a fixed maximum percentage of the revenue to be credited; and
(iii) determining the portion of the revenue to be credited, based on the percentage of questions answered, the fixed minimum percentage and the fixed maximum percentage.

20. The method of claim 17, further comprising:
(d) electronically soliciting the listed individual to agree to a predetermined set of conditions regarding the provision and handling of personal data related to the listed individual; and
(e) the list owner electronically receiving an indication that the listed individual agrees to the predetermined set of conditions.

21. The method of claim 20, wherein the predetermined set of conditions include the listed individual agreeing to provide personal data related to the listed individual that will be included on a list that is to be included in a future transaction that generates revenue, to update the personal data on a periodic basis, and be subject to targeted messages based on the personal data.

22. The method of claim 17, wherein the personal data includes at least one of the listed individual's name, telephone number, home address, e-mail address, employer name, employer address, job title, age, income, education, interests, recreational preferences, food preferences, home ownership or rental status, medical ailments, medication intake and marital status.

23. An article of manufacture for sharing revenue with listed individuals, wherein the listed individuals provide personal data to a list owner and agree to allow the list owner to make the personal data accessible to a list user, the listed individuals communicating with the list owner via an electronic communication medium, the article of manufacture comprising a computer-readable medium holding computer-executable instructions for performing a method comprising:
(a) electronically soliciting a listed individual to agree to a predetermined set of conditions regarding the provision and handling of personal data related to the listed individual;
(b) electronically receiving an indication that the listed individual agrees to the predetermined set of conditions;
(c) electronically soliciting the listed individual for personal data;
(d) electronically receiving and storing personal data related to the listed individual;
(e) determining, on a periodic basis, whether revenue was received in exchange for providing the list user with access to a list including the personal data of the listed individual, and, if so, determining a portion of the revenue to be credited to the listed individual.

24. The article of manufacture of claim 23, wherein the solicitation in step (a) includes an offer to credit to the listed individual a portion of future revenue to be received from the sale, rental or exchange of one or more lists that include the listed individual's personal data to a list user.

25. The article of manufacture of claim 23, wherein the personal data includes answers to questions presented in a questionnaire.

26. The article of manufacture of claim 23, wherein step (e) further comprises:
(i) determining the percentage of the questions in the questionnaire that were answered by the listed individual; and
(ii) determining the portion of the revenue to be credited to the listed individual based on the percentage of questions answered.

27. The article of manufacture of claim 26, wherein step (e)(ii) further comprises:
(a) setting a fixed minimum percentage of the revenue to be credited;
(b) setting a fixed maximum percentage of the revenue to be credited; and
(c) determining the portion of the revenue to be credited, based on the percentage of questions answered, the fixed minimum percentage and the fixed maximum percentage.

28. The article of manufacture of claim 23, wherein the computer-executable instructions perform a method further comprising:
(f) electronically requesting, on a periodic basis, the listed individual to update the personal data related to the listed individual; and
(g) the list owner electronically receiving and storing updated personal data associated with the listed individual.

29. The article of manufacture of claim 28, wherein step (e) further comprises:
(i) evaluating the listed individual's responsiveness to the periodic requests to update personal data related to the listed individual; and
(ii) determining the portion of the revenue to be credited to the listed individual based on the evaluation of the listed individual's responsiveness.

30. The method of claim 29, wherein step (e)(ii) further comprises:
(a) setting a fixed minimum percentage of the revenue to be credited;
(b) setting a fixed maximum percentage of the revenue to be credited; and
(c) determining the portion of the revenue to be credited, based on the evaluation of the listed individual's responsiveness, the fixed minimum percentage and the fixed maximum percentage.

31. The article of manufacture of claim 23, wherein the predetermined set of conditions include the listed individual agreeing to provide personal data related to the listed individual that will be included on a list that is to be included in a future transaction that generates revenue, update the personal data on a periodic basis, and be subject to targeted messages based on the personal data.

32. The article of manufacture of claim 23, wherein the personal data includes at least one of the listed individual's name, telephone number, home address, e-mail address, employer name, employer address, job title, age, income, education, interests, recreational preferences, food preferences, home ownership or rental status, medical ailments, medication intake and marital status.

33. An article of manufacture for sharing revenue with listed individuals, wherein the listed individuals provide personal data to a list owner and agree to allow the list owner to make the personal data accessible to a list user, the listed individuals communicating with the list owner via an electronic communication medium, the article of manufacture comprising a computer-readable medium holding computer-executable instructions for performing a method comprising:
(a) electronically soliciting a listed individual for personal data;
(b) electronically receiving and storing personal data related to the listed individual;
(c) electronically requesting, on a periodic basis, the listed individual to update the personal data related to the listed individual; and
(d) determining, on a periodic basis, the portion of the revenue to be credited to the listed individual based on whether or not revenue was received in exchange for providing the list user with access to a list including the listed individual's personal data, and an evaluation of the responsiveness of the listed individual to the periodic requests to update personal data associated with the listed individual.

34. The article of manufacture of claim 33, wherein the solicitation in step (a) includes an offer to credit to the listed individual a portion of future revenue to be received from the sale, rental or exchange of one or more lists that include the listed individual's personal data to a list user.

35. The article of manufacture of claim 33, wherein if revenue was received, step (d) further comprises:
(i) setting a fixed minimum percentage of the revenue to be credited;
(ii) setting a fixed maximum percentage of the revenue to be credited; and
(iii) determining the portion of the revenue to be credited, based on the evaluation of the listed individual's responsiveness, the fixed minimum percentage and the fixed maximum percentage.

36. The article of manufacture of claim 33, wherein the computer-executable instructions perform a method further comprising:
(e) electronically soliciting the listed individual to agree to a predetermined set of conditions regarding the provision and handling of personal data related to the listed individual; and
(f) the list owner electronically receiving an indication that the listed individual agrees to the predetermined set of conditions.

37. The method of claim 36, wherein the predetermined set of conditions include the listed individual agreeing to provide personal data related to the listed individual that will be included on a list that is to be included in a future transaction that generates revenue, update the personal data on a periodic basis, and be subject to targeted messages based on the personal data.

38. The article of manufacture of claim 33, wherein the personal data includes at least one of the listed individual's name, telephone number, home address, e-mail address, employer name, employer address, job title, age, income, education, interests, recreational preferences, food preferences, home ownership or rental status, medical ailments, medication intake and marital status.

39. An article of manufacture for sharing revenue with listed individuals, wherein the listed individuals provide personal data to a list owner and agree to allow the list owner to make the personal data accessible to a list user, the listed individuals communicating with the list owner via an electronic communication medium, comprising a computer-readable medium holding computer-executable instructions for performing a method comprising:
(a) electronically soliciting a listed individual for personal data related to the listed individual, wherein the personal data includes answers to questions presented in a questionnaire;
(b) electronically receiving and storing personal data related to the listed individual; and
(c) determining, on a periodic basis, the portion of the revenue to be credited to the listed individual based on whether or not revenue was received in exchange for providing the list user with access to a list including the personal data of the listed individual, and the percentage of the questions in the questionnaire that were answered by the listed individual.

40. The article of manufacture of claim 39, wherein the solicitation in step (a) includes an offer to credit to the listed individual a portion of future revenue to be received from the sale, rental or exchange of one or more lists that include the listed individual's personal data.

41. The article of manufacture of claim 39, wherein if revenue was received, step (c) further comprises:
(i) setting a fixed minimum percentage of the revenue to be credited;
(ii) setting a fixed maximum percentage of the revenue to be credited; and
(iii) determining the portion of the revenue to be credited, based on the percentage of questions answered, the fixed minimum percentage and the fixed maximum percentage.

42. The article of manufacture of claim 39, wherein the computer-executable instructions perform a method further comprising:
(d) electronically soliciting the listed individual to agree to a predetermined set of conditions regarding the provision and handling of personal data related to the listed individual; and
(e) the list owner electronically receiving an indication that the listed individual agrees to the predetermined set of conditions.

43. The article of manufacture of claim 42, wherein the predetermined set of conditions include the listed individual agreeing to provide personal data related to the listed individual that will be included on a list that is to be included in a future transaction that generates revenue, to update the personal data on a periodic basis, and be subject to targeted messages based on the personal data.

44. The method of claim 39, wherein the personal data includes at least one of the listed individual's name, telephone number, home address, e-mail address, employer name, employer address, job title, age, income, education, interests, recreational preferences, food preferences, home ownership or rental status, medical ailments, medication intake and marital status.
